(19) United States
(12) Patent Application Publication
(10) Pub. No.: US 2010/0096073 A1
(43) Pub. Date: Apr. 22, 2010

(54) COMPRESSION OR ARCHED MOUNTING OF SOLAR PANELS

(76) Inventors: Paul M. Adriani, Palo Alto, CA (US); Robert Stancel, Los Altos, CA (US); Louis Basel, San Jose, CA (US); Steve Marsh, San Jose, CA (US)

Correspondence Address: Director of IP, 5521 Hellyer Avenue, San Jose, CA, 95138, US

(21) Appl. No.: 12/561,254

(22) Filed: Sep. 16, 2009

Related U.S. Application Data
(60) Provisional application No. 61/097,518, filed on Sep. 16, 2008.

(51) Int. Cl. B29C 65/00

(52) U.S. Cl. 156/160

(57) ABSTRACT

Methods and devices are provided for solar panel installation. In one embodiment, a photovoltaic panel system for use with a support grid is provided. The system comprises of a photovoltaic panel with at least one layer comprised of a glass layer; a compression mechanism configured to laterally compress the glass layer in at least a first axis in a plane of the glass layer when the panel is mounted to the support grid. In one embodiment, the glass layer comprises of an un-tempered glass material. In another embodiment, the glass layer comprises of a tempered glass material. Optionally, other substantially transparent material may be used with or in place of the glass.

### CROSS-REFERENCE TO RELATED APPLICATION

This application claims priority to U.S. Provisional Application Ser. No. 61/097,518 filed Sep. 16 2008 and fully incorporated herein by reference for all purposes.

### FIELD OF THE INVENTION

This invention relates generally to photovoltaic devices, and more specifically, to a mounting apparatus for solar cells and/or solar cell panels.

### BACKGROUND OF THE INVENTION

Solar cells and solar cell panels convert sunlight into electricity. Traditional solar cell panels are typically comprised of polycrystalline and/or monocrystalline silicon solar cells mounted on a support with a rigid glass top layer to provide environmental and structural protection to the underlying silicon based cells. This package is then typically mounted in a rigid aluminum or metal frame that supports the glass and provides attachment points for securing the solar panel to the installation site. A host of other materials are also included to make the solar panel functional. This may include junction boxes, bypass diodes, sealants, and/or multi-contact connectors used to complete the panel and allow for electrical connection to other solar panels and/or electrical devices. Certainly, the use of traditional silicon solar cells with conventional panel packaging is a safe, conservative choice based on well understood technology.

Drawbacks associated with traditional solar panel package designs, however, have limited the ability to install large numbers of solar panels in a cost-effective manner. This is particularly true for large scale deployments where it is desirable to have large numbers of solar panels setup in a defined, dedicated area. Traditional solar panel packaging comes with a great deal of redundancy and excess equipment cost. For example, a recent installation of conventional solar panels in Pocking, Germany deployed 57,912 monocrystalline and polycrystalline-based solar panels. This meant that there were also 57,912 junction boxes, 57,912 aluminum frames, untold meters of cablings, and numerous other components. These traditional panel designs inherit a large number of legacy parts that hamper the ability of installers to rapidly and cost-efficiently deploy solar panels at a large scale.

Additionally, the ability to create larger solar panels and/or solar panels using less expensive material has also been limited due to the load requirements that solar panels meet to gain certification. The ability to make such panels is restricted by these load requirements.

Although subsidies and incentives have created some large solar-based electric power installations, the potential for greater numbers of these large solar-based electric power installations has not been fully realized. There remains substantial improvement that can be made to photovoltaic cells and photovoltaic panels that can greatly increase their ease of installation, and create much greater market penetration and commercial adoption of such products.

### SUMMARY OF THE INVENTION

Embodiments of the present invention address at least some of the drawbacks set forth above. The present invention provides for the improved solar panel designs that reduce manufacturing costs while still allowing the panel to withstand wind and/or snow loads. These improved panel designs are well suited for rapid installation. It should be understood that at least some embodiments of the present invention may be applicable to any type of solar cell, whether they are rigid or flexible in nature or the type of material used in the absorber layer. Embodiments of the present invention may be adaptable for roll-to-roll and/or batch manufacturing processes. At least some of these and other objectives described herein will be met by various embodiments of the present invention.

In one embodiment of the present invention, a method is provided comprising: compression mounting a photovoltaic panel such that at least one rigid or semi-rigid layer of the photovoltaic panel is a constant state of compression in at least a first axis when the photovoltaic panel is mounted for use. The mounting apparatus is configured to prevent upward force that exceeds 2400 pa.

It should be understood that one or more embodiments herein may be configured to have one or more of the following features. For example, in one embodiment, the layer in the constant state of compression comprises a glass layer. Optionally, the layer comprises of an un-tempered glass material. Optionally, the layer comprises of a tempered glass material. Optionally, one layer is tempered and one is un-tempered. Optionally, all glass layers are un-tempered. Optionally, the panel has a total photovoltaic surface area of at least 0.5 m². Optionally, the panel has a total photovoltaic surface area of at least 0.7 m². Optionally, the panel has a total photovoltaic surface area of at least 1 m². Optionally, the panel has a total photovoltaic surface area of at least 1.5 m². Optionally, the panel has a total photovoltaic surface area of at least 2 m². Optionally, compression is applied in an amount sufficient for the panel to withstand a load of at least 2400 pa without breakage that an identical panel without the compression mounting could not withstand. Optionally, compression is applied in an amount sufficient for the panel to withstand a load of at least 4000 pa without breakage that an identical panel without the compression mounting could not withstand. Optionally, compression is applied in an amount sufficient for the panel to withstand a load of at least 5400 pa without breakage that an identical panel without the compression mounting could not withstand. Optionally, compression is applied in an amount sufficient for the panel to withstand a load of at least 7500 pa without breakage that an identical panel without the compression mounting could not withstand. Optionally, compression is applied in an amount sufficient for the panel to withstand a load of at least 10000 pa without breakage that an identical panel without the compression mounting could not withstand. Optionally, the layer being compressed is a front-side layer of the panel. Optionally, the layer being compressed is a back-side layer of the panel. Optionally, all layers are in compression in steady state after mounting. Optionally, at least two layers of the panel are in a constant state of compression when the panel is mounted for use. Optionally, compressing the layer compressions the entire panel in one axis. Optionally, the method includes attaching a mounting bracket directly in contact to the layer to be placed in constant compression. Optionally, the mounting bracket is glued to the layer. Optionally, the mounting bracket is mechanically fastened to the layer. Optionally, the mounting bracket is clamped to the layer. Optionally, the panel has a roughed surface at an area where the mounting bracket attaches to the layer to facilitate attachment. Optionally, the panel has a round surface at an area where the mounting bracket attaches to the layer to facilitate attachment. Optionally, the panel has at least one hole at an area where the mounting bracket attaches to the layer to facilitate attachment. Optionally, the method includes using a mounting bracket that is configured to allow the panel to flex in one axis. Optionally, the method includes attaching a plurality of cables to the panel to provide compression. Optionally, the method includes attaching a separate layer of material to extend across an entire underside of the panel and compressing that separate layer compressions the layer in the panel. Optionally, the method includes attaching a net-like layer of material to extend across an entire underside of the panel and compressing that net-like layer compressions the layer in the panel. Optionally, the method includes attaching a separate layer of material between a topside layer of the panel and an bottom layer of the panel, wherein the separate layer extends across the panel in one axis and compressing that separate layer compressions the layer in the panel. Optionally, the method includes attaching a net-like layer of material between a topside layer of the panel and an bottom layer of the panel, wherein the net-like layer extends across the panel in one axis and compressing that net-like layer compressions the layer in the panel. Optionally, compression is applied laterally through the layer in constant compression. Optionally, compression is applied in-plane through the layer in constant compression. Optionally, the method includes using a compressing mechanism that compresses within a range of angles between about 0 to about 45 degrees relative to a plane of the panel. Optionally, the panel is not supported other than through restoring force provided by a compression mechanism. Optionally, the panel is a frameless panel. Optionally, the panel is a perimeter framed panel.

In one embodiment of the present invention, a photovoltaic panel system is provided comprising a photovoltaic panel; and a compressing mechanism configured to place at least one layer of the photovoltaic panel in compression in at least a first axis when the photovoltaic panel is mounted for use; wherein compression is applied in an amount sufficient for the panel to withstand a load of at least 2400 pa without breakage that an identical panel without the compression mounting could not withstand.

In another embodiment, a photovoltaic panel system for use with a support grid is provided comprising a photovoltaic panel with at least one layer comprised of a glass layer; a compressing mechanism configured to laterally compression the glass layer in at least a first axis in a plane of the glass layer when the panel is mounted to the support grid, wherein the photovoltaic panel has a total photovoltaic surface area of at least 0.5 m². Optionally, the glass layer comprises of an un-tempered glass material. Optionally, the panel is not supported other than through restoring force provided by the compression mechanism.

In another embodiment, a photovoltaic panel system is provided comprising a photovoltaic panel; and a compressing mechanism configured to place at least one layer of the photovoltaic panel in compression in at least a first axis when the photovoltaic panel is mounted for use; wherein the panel comprises of at least one layer of un-tempered glass and the panel has a total photovoltaic surface area of at least 1.0 m2.

In a still further embodiment, a photovoltaic panel system for use with a support grid is provided comprising a photovoltaic panel with at least one layer comprised of a glass layer; a compressing mechanism configured such that the glass layer is in compression when the panel is in steady state, without any load.

In yet another embodiment of the present invention, a photovoltaic panel system for use with a support grid is provided comprising a plurality of photovoltaic panels configured to form a string of panels, wherein each of the panels has at least one layer comprised of a glass layer; and a compressing mechanism configured to simultaneously compression each glass layer in the string of panels.

In yet another embodiment of the present invention, a method of panel mounting is provided comprising providing a photovoltaic panel; coupling the panel to a support rail; compressing the panel so that the panel can withstand greater downward load, relative to a substantially identical panel that is not compressed.

In another embodiment of the present invention, a method of panel mounting is provided comprising compression mounting a photovoltaic panel with at least one substantially rigid layer, wherein the panel in its mounted configuration is in a compressioned state when no weight is on the panel.

In another embodiment of the present invention, a method is provided comprising arched mounting a photovoltaic panel to structurally change the panel shape such that at least one rigid or semi-rigid layer of the photovoltaic panel is in a constant arched configuration in at least a first axis when the photovoltaic panel is mounted for use.

A further understanding of the nature and advantages of the invention will become apparent by reference to the remaining portions of the specification and drawings.

### BRIEF DESCRIPTION OF THE DRAWINGS

FIG. 1 is an exploded perspective view of a panel according to one embodiment of the present invention.

FIG. 2 is a side view of the embodiment of FIG. 1.

FIG. 3 shows a perspective view of a panel in an arched configuration according to one embodiment of the present invention.

FIGS. 4 and 5 show side views of panels according to various embodiments of the present invention.

FIG. 6 shows a perspective view of a panel in an arched configuration according to one embodiment of the present invention.

FIGS. 7 and 8 show side views of panels according to various embodiments of the present invention.

FIGS. 9 and 10 show side views of panels according to various embodiments of the present invention.

FIG. 11 shows a self-locking mechanism for use with a solar panel according to one embodiment of the present invention.

FIGS. 12 through 14 show side views of panels according to various embodiments of the present invention.

FIGS. 15A through 15F show views of panels according to various embodiments of the present invention.

FIGS. 16A through 16B show top down plan views of panels according to various embodiments of the present invention.

FIGS. 17A through 17B show bottom up plan views of panels according to various embodiments of the present invention.

FIG. 18 shows a perspective view of one embodiment of the present invention.

FIGS. 19A through 19C show top down plan views of panels according to various embodiments of the present invention.

FIG. 20 shows a side cross-sectional view of one portion of a panel according to an embodiment of the present invention.

FIGS. 21 through 22 show bottom up plan views of panels according to various embodiments of the present invention.

FIGS. 23 through 24 show a plurality of solar panels in compression and mounted on an arched support according to various embodiments of the present invention.

FIGS. 25 through 32 show various arrays of solar panels mounted according to embodiments of the present invention.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for an anti-reflective film, this means that the anti-reflective film feature may or may not be present, and, thus, the description includes both structures wherein a device possesses the anti-reflective film feature and structures wherein the anti-reflective film feature is not present.

### Photovoltaic Panel

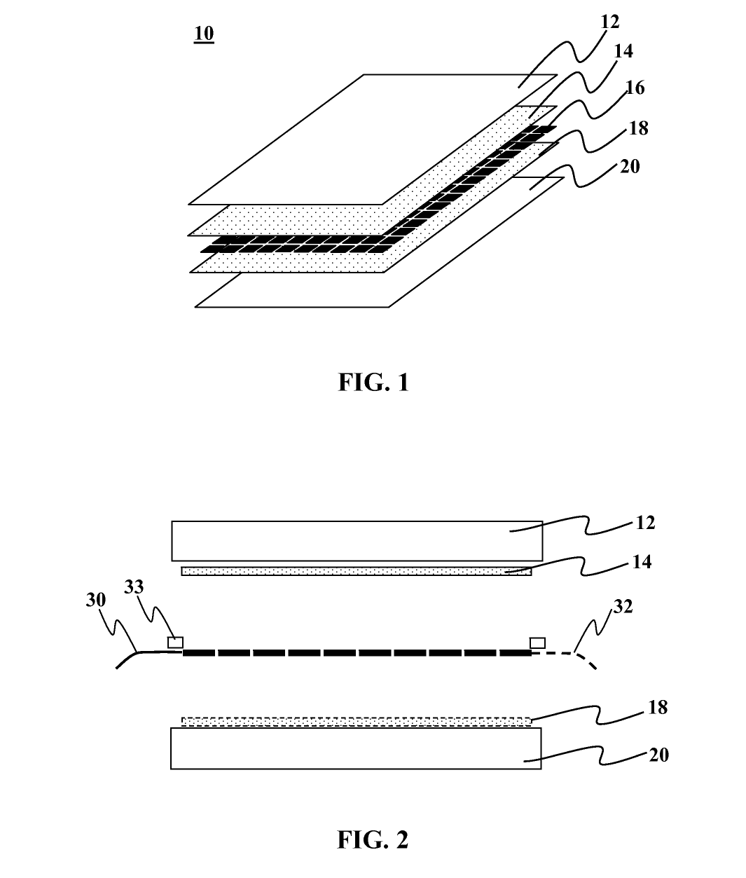

Referring now to FIG. 1, one embodiment of a panel 10 according to the present invention will now be described. Traditional panel packaging and system components were developed in the context of legacy cell technology and cost economics, which had previously led to very different panel and system design assumptions than those suited for increased product adoption and market penetration. The cost structure of solar panels includes both factors that scale with area and factors that are fixed per panel. Panel 10 is designed to minimize fixed cost per panel and decrease the incremental cost of having more panels while maintaining substantially equivalent qualities in power conversion and panel durability. In this present embodiment, the panel 10 may include improvements to the backsheet, frame modifications, thickness modifications, and electrical connection modifications.

FIG. 1 shows that the present embodiment of panel 10 may include a rigid transparent upper layer 12 followed by a pottant layer 14 and a plurality of solar cells 16. Below the layer of solar cells 16, there may be another pottant layer 18 of similar material to that found in pottant layer 14. Beneath the pottant layer 18 may be a layer of backsheet material 20. The transparent upper layer 12 may provide structural support and/or act as a protective barrier. By way of nonlimiting example, the transparent upper layer 12 may be a glass layer comprised of materials such as conventional glass, solar glass, high-light transmission glass with low iron content, standard light transmission glass with standard iron content, anti-glare finish glass, glass with a stippled surface, fully tempered glass, heat-strengthened glass, annealed glass, or combinations thereof. By way of example and not limitation, the total thickness of the glass or multi-layer glass may be in the range of about 2.0 mm to about 13.0 mm, optionally from about 2.8 mm to about 12.0 mm. Some embodiments may have even thinner glass, such as from 01-1.0 mm. In one embodiment, the top layer 12 has a thickness of about 3.2 mm. In another embodiment, the backlayer 20 has a thickness of about 2.0 mm. As a nonlimiting example, the pottant layer 14 may be any of a variety of pottant materials such as but not limited to Tefzel®, ethyl vinyl acetate (EVA), polyvinyl butyral (PVB), ionomer, silicone, thermoplastic polyurethane (TPU), thermoplastic elastomer polyolefin (TPO), tetrafluoroethylene hexafluoropropylene vinylidene (THV), fluorinated ethylene-propylene (FEP), saturated rubber, butyl rubber, thermoplastic elastomer (TPE), flexibilized epoxy, epoxy, amorphous polyethylene terephthalate (PET), urethane acrylic, acrylic, other fluoroelastomers, other materials of similar qualities, or combinations thereof. Optionally, some embodiments may have more than two pottant layers. The thickness of a pottant layer may be in the range of about 10 microns to about 1000 microns, optionally between about 25 microns to about 500 microns, and optionally between about 50 to about 250 microns. Others may have only one pottant layer (either layer 14 or layer 16). In one embodiment, the pottant layer 14 is about 75 microns in cross-sectional thickness. In another embodiment, the pottant layer 14 is about 50 microns in cross-sectional thickness. In yet another embodiment, the pottant layer 14 is about 25 microns in cross-sectional thickness. In a still further embodiment, the pottant layer 14 is about 10 microns in cross-sectional thickness. The pottant layer 14 may be solution coated over the cells or optionally applied as a sheet that is laid over cells under the transparent panel layer 12.

It should be understood that the simplified panel 10 is not limited to any particular type of solar cell. The solar cells 16 may be silicon-based or non-silicon based solar cells. By way of nonlimiting example the solar cells 16 may have absorber layers comprised of silicon (monocrystalline or polycrystalline), amorphous silicon, organic oligomers or polymers (for organic solar cells), bi-layers or interpenetrating layers or inorganic and organic materials (for hybrid organic/inorganic solar cells), dye-sensitized titania nanoparticles in a liquid or gel-based electrolyte (for Graetzel cells in which an optically transparent film comprised of titanium dioxide particles a few nanometers in size is coated with a monolayer of charge transfer dye to sensitize the film for light harvesting), copper-indium-gallium-selenium (for CIGS solar cells), CdSe, CdTe, Cu(In,Ga)(S,Se)₂, Cu(In,Ga,Al)(S,Se,Te)₂, and/or combinations of the above, where the active materials are present in any of several forms including but not limited to bulk materials, micro-particles, nano-particles, or quantum dots. Advantageously, thin-film solar cells have a substantially reduced thickness as compared to silicon-based cells. The decreased thickness and concurrent reduction in weight allows thin-film cells to form panels that are significantly thinner than silicon-based cells without substantial reduction in structural integrity (for panels of similar design).

The pottant layer 18 may be any of a variety of pottant materials such as but not limited to EVA, Tefzel®, PVB, ionomer, silicone, TPU, TPO, THV, FEP, saturated rubber, butyl rubber, TPE, flexibilized epoxy, epoxy, amorphous PET, urethane acrylic, acrylic, other fluoroelastomers, other materials of similar qualities, or combinations thereof as previously described for FIG. 1. The pottant layer 18 may be the same or different from the pottant layer 14. Further details about the pottant and other protective layers can be found in commonly assigned, co-pending U.S. patent application Ser. No. 11/462,359 (Attorney Docket No. NSL-090) filed Aug. 3, 2006 and fully incorporated herein by reference for all purposes. Further details on a heat sink coupled to the panel can be found in commonly assigned, co-pending U.S. patent application Ser. No. 11/465,783 (Attorney Docket No. NSL-089) filed Aug. 18, 2006 and fully incorporated herein by reference for all purposes.

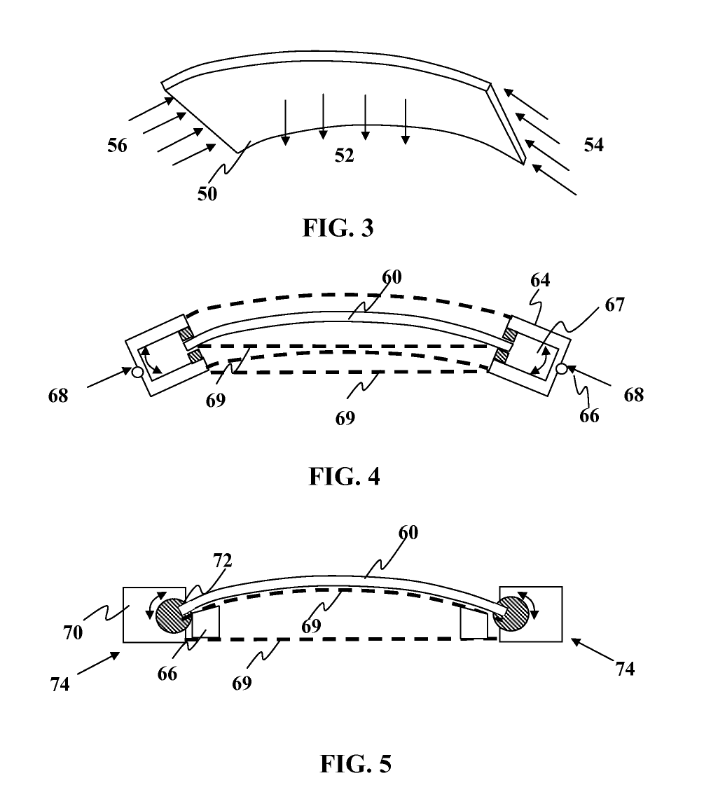

FIG. 2 shows a cross-sectional view of the panel of FIG. 1. By way of nonlimiting example, the thicknesses of backsheet 20 may be in the range of about 10 microns to about 1000 microns, optionally about 20 microns to about 500 microns, or optionally about 25 to about 250 microns. Again, as seen for FIG. 2, this embodiment of panel 10 is a frameless panel without a central junction box. The present embodiment may use a simplified backsheet 20 that provides protective qualities to the underside of the panel 10. As seen in FIG. 1, the panel may use a rigid backsheet 20 comprised of a material such as but not limited to annealed glass, heat strengthened glass, tempered glass, flow glass, cast glass, or similar materials as previously mentioned. The rigid backsheet 20 may be made of the same or different glass used to form the upper transparent panel layer 12. Optionally, in such a configuration, the top sheet 12 may be a flexible top sheet such as that set forth in U.S. patent application Ser. No. ______ (Attorney Docket No. NSL-085) filed Jun. 28, 2007 and fully incorporated herein by reference for all purposes. In one embodiment, electrical connectors 30 and 32 may be used to electrically couple cells to other panels or devices outside the panel 10. A moisture barrier material 33 may also be included along a portion or all of the perimeter of the panel.

### Panel Support System

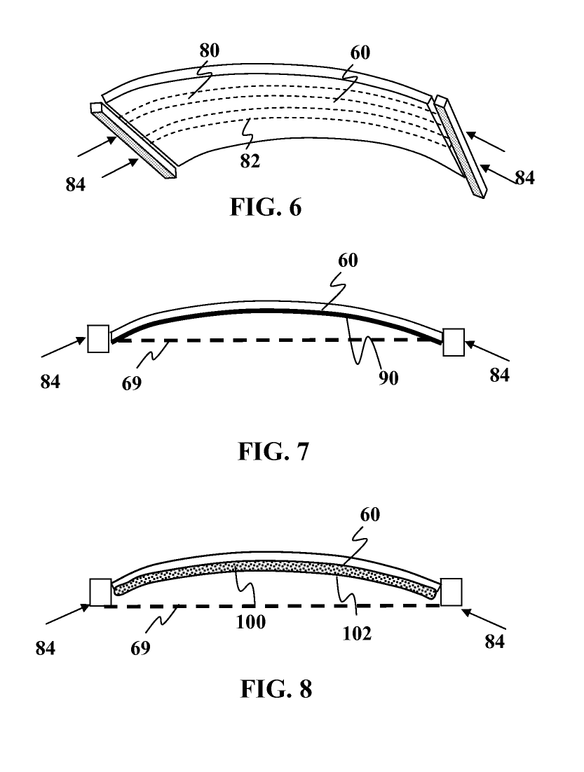

Referring now to FIG. 3, one aspect of the present invention will now be described. FIG. 3 shows a panel (unframed or framed) with at least one rigid layer 50 under a static downward load as indicated by arrows 52. For ease of illustration, only the layer 50 is clearly shown but it should be understood that a stack of one or more other layers may be above or below layer 50. In one embodiment, the amount of pressure from the downward load is at least 2400 pa. To reduce the thickness of the rigid or semi-rigid layer 50, to increase load carrying ability, and/or to use materials of less strength, compression may be applied to layer 50 as indicated by arrows 54 and 56. In one embodiment, this compression may result in an arched configuration as shown in FIG. 3. Optionally, other embodiments may be braced so that the panel remains in a substantially flat configuration of less than 2% deflection (up or down)

In the present embodiment, the compression is present in the panel even when it is not loaded by downward load 52. The compression may be viewed as being applied in at least one axis of the rigid or substantially rigid layer (when the panel or the rigid layer is in a flat planar configuration). Optionally, by way of example and not limitation, the panel in its resting mode, even when compressed or not, may be in a flat, concave, and/or convex shape. Thus in some embodiments, even in resting mode, the layer 50 is curved out-of-plane and is in a non-planar configuration. This may be a result of pre-bowing that may occur when the panel is manufactured such that it is laminated, shaped, or molded to have a curved configuration (either along an X axis and/or a Y axis in the plane of the panel).

The compression of the rigid or semi-rigid layer 50 and/or other layers in the panel, increases the amount of downward load that the layer 50 can withstand before breakage. By way of example and not limitation, a material such as glass under compression will bend/deflect less and allow a layer of such material to carry more load before it bends/deflects to an amount that causes catastrophic failure. The delayed fracture of glass under compression can allow for larger panels to be made that can still withstand 2400 pa load without failure. In one embodiment, the panel is mounted so that the panel is in compression even when there is no load on the panel (other than the panel's own weight). In one embodiment, the compression is uniformly distributed. In other embodiments, the compression is distributed mainly over certain key locations. In one embodiment, the amount of compression may be in the range of about 1000 lb to about 16000 lb. Optionally, the amount of compression may be in the range of about 500 lb to about 20000 lb. Optionally, the amount of compression may be in the range of about 100 lb to about 500 lbs. Optionally, the amount of compression may be in the range of about 200 lb to about 2000 lbs. Optionally, some embodiments are curved but not under any compression until downward load is applied. In one nonlimiting example, a glass-glass laminated panel 1 m×2 m long with a thickness of about 6 mm and arched along its short axis at an angle of about 8 degrees relative to horizontal allows for a load carrying capacity of about 10000 Pa prior to failure. In other embodiments, the angle may be between about 1 degree to about 30 degrees.

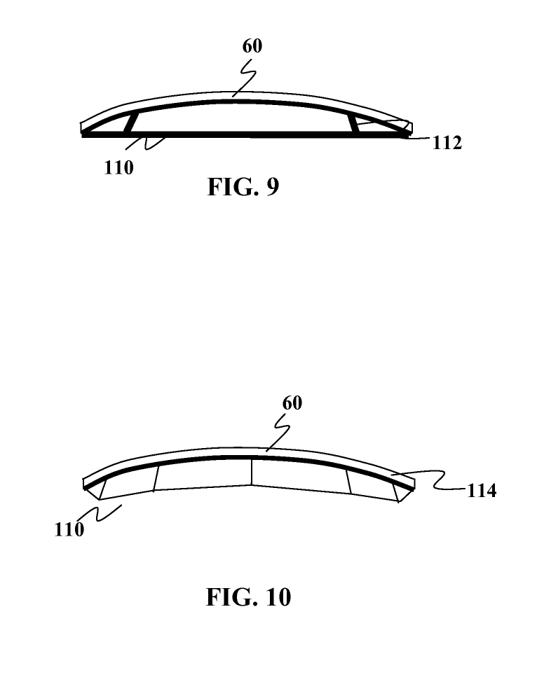

FIG. 4 shows one embodiment of the present invention wherein the panel 60 is mounted between hinged mounting brackets 64 that have a hinge 66. This allows the compression to be applied to the panel 60 without creating stress concentrations that would otherwise occur if the brackets 64 were rigidly secured. In this manner, the panel 60 can flex while compression 68 is transmitted through the plane of the panel 60. The panel 60 may be glued, clamped, screwed, bolted, fastened, and/or otherwise attached to the bracket 64. In some embodiments, the area 67 is filled with material to allow compressive force to be applied.

As seen in FIG. 4, optionally, it may be desirable to run one or more compression maintaining members 69 from mounting bracket 64 to mounting bracket 64. Optionally, the member 69 may be attached directly to the panel 60. By running a supporting compression member 69 under the panel 60 (one or several, across whole length or just part, two connecting the four clips etc.) from mounting device to mounting device (e.g. clip or bracket) or from panel anchor point to panel anchor point, the panel 60 in such an embodiment may lean on this compression member 69. This may be similar to ribs mounted to the bottom of the panel, except now it is not ribs but cable, ribbon, fiber layer, sheet, or the like. This embodiment works if compression is applied to the cable, potentially significant compression. The compression members 69 can be, but are not limited to, steel cable, ribbon, nylon webbing ribbon, any woven or solid sheet of textile, polymer, glass or other fiber, metal etc. sheet, film etc. between the clip areas. Some embodiments may have these compression maintaining members 69 above and/or below the panel. If above the panel, the members 69 may be transparent or may be spaced apart elongate structures such as but not limited to wires. Some embodiments may the member 69 running in a straight line. Optionally, the hinged bracket 64 is in an anchored position such that it is held in place so that compression is applied to the panels when the panels carry downward load. Some embodiments may also have spacers 66 (see FIG. 5) below to prevent deflection beyond a certain pre-determined amount.

FIG. 5 shows another embodiment of the present invention wherein the mounting bracket 70 is rigidly secured, but inside the bracket 70, there is a rotatable portion 72 that allows the panel 60 to deflect without creating stress concentrations at that attachment points of the panel 60 to the rotatable portion 72. Again, in this manner, the panel 60 can flex while compression 74 is transmitted through the plane of the panel 60. The panel 60 may be glued, clamped, screwed, bolted, fastened, and/or otherwise attached to the rotatable portion 72 in the bracket 70. Optionally, as in FIG. 4, a compression member 69 may be attached to the bracket 70, such as but not limited to attachment to the rotatable portion 72. Some embodiments may attach the compression member 69 to a non-rotatable portion of the mounting device 70.

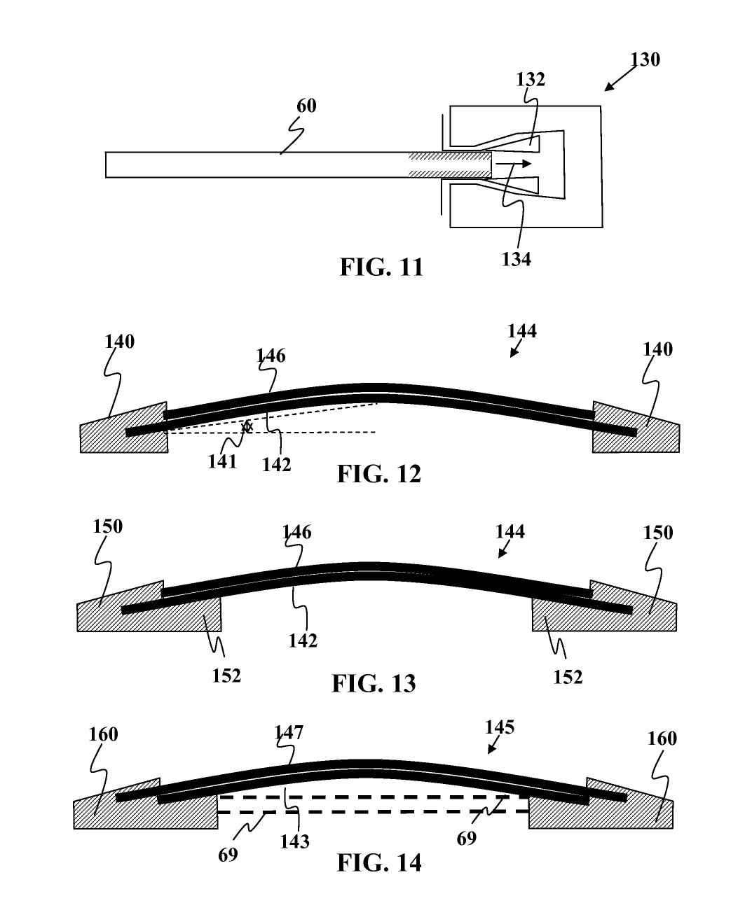

Referring now to FIG. 6, yet another embodiment of the present invention will now be described. It should be understood that the layer in compression may actually be a ribbon, cable, belt, foil, or other configuration. As seen in FIG. 6, in this embodiment, the strip 80 and 82 (shown in phantom) may be positioned along the underside of panel 60. The strips 80 and 82 are in compression as indicated by arrows 84. There may be more strips used than those shown in FIG. 6 and those shown in FIG. 6 are merely exemplary. It should also be understood that in some embodiments, the strips 80 and 82 are also adhered, fastened, or otherwise attached to the panel 60 so that compression in the strips 80 and 82 are transferred to one or more layers in the panel 60. Optionally, in some embodiments, the panel 60 is not attached to the strips 80 and 82 in a manner where compression is transferred into the panel 60. By way of nonlimiting example, the panel may be slidably mounted over the strips 80 and/or 82.

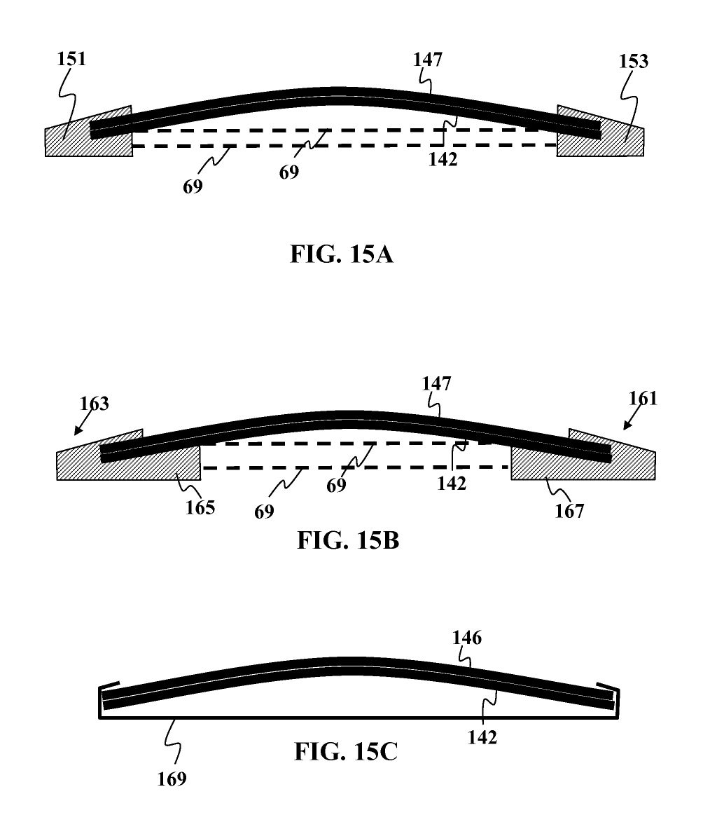

FIG. 7 shows a still further embodiment wherein an entire sheet or layer 90 is attached to the underside of panel 60. In one embodiment, this allows the compressed layer to transfer forces more uniformly across the backside of the panel. In another embodiment, the panel 60 is not attached to the layer 90 in a manner where compression is transferred into the panel 60. In some embodiments, the layer is a solid layer. Optionally, it may be a patterned layer such as but not limited to a grid, wire, or net-like layer. Optionally, it may be shaped layer such as but not limited to a corrugated layer. Optionally, the layer may be a webbing, netting or similar layer that is non-solid.

Referring now to FIG. 8, yet another embodiment of the present invention uses a panel 60 with a back layer 100 and a “spacer” layer 102 comprised of material such as but not limited to foam, honeycomb, or other porous material. The spacer layer 102 creates separation between the panel 60 and the back layer 100. This gives more rigidity which may also help reduce deflection of the panel during load and maintain the arched configuration. The spacer layer 102 may stretch across strips, portions, and/or all of the backside of the panel 60. In one embodiment, the layer 102 may be configured to be in the curved configuration during steady state, resting mode. Optionally, in other embodiments, it may be in a flat, non-curved configuration.

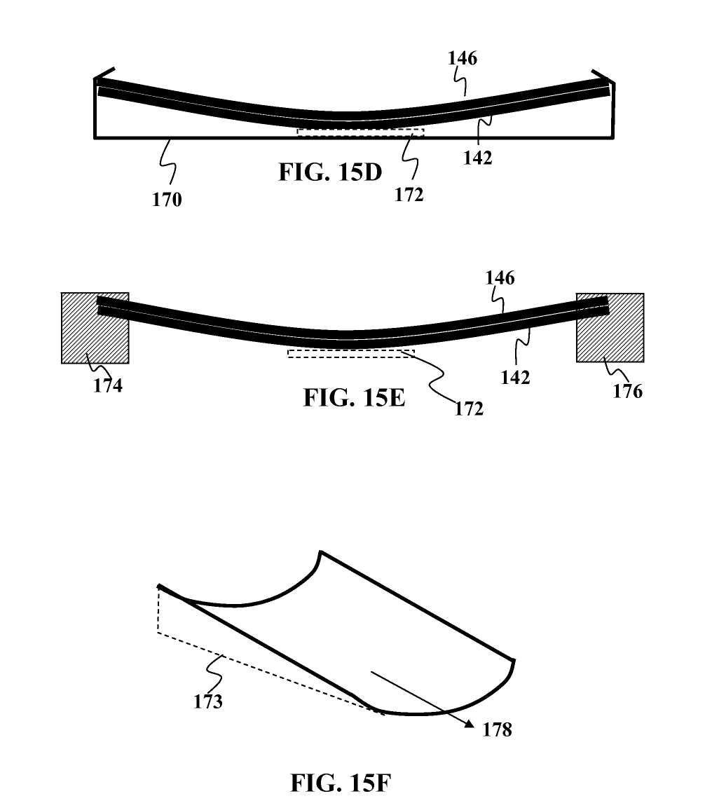

Referring now to FIG. 9, also relevant is a cable-tied bridge construction that creates a distance between panel 60 and compression member 110. The spacer 112 can be on singular points, in several points, and/or along a line or covering a whole surface (which then can be a honeycomb structure, foam etc. if the compression member is so wide to basically create a complete back sheet such as that shown in FIG. 8). The present embodiment is differentiated between the compression member being attached to clips/mounting structure, or to the panel, i.e. there are spacers (or none) in the panel middle, but towards the ends the member is attached to the panel without spacers. Imagine a pillow shape with varying thickness foam or similar inbetween. The member 110 may be used to hold the panel

FIG. 10 shows an embodiment wherein there are a plurality of spacers 114 to separate the compression member 110 from the panel 60. These spacers 114 may be of the same or different size and are positioned to more evenly transfer load between the compression member 110 and the panel 60. The compression member may be glued, clipped, integrally formed, mechanically fastened, or otherwise coupled to the panel 60.

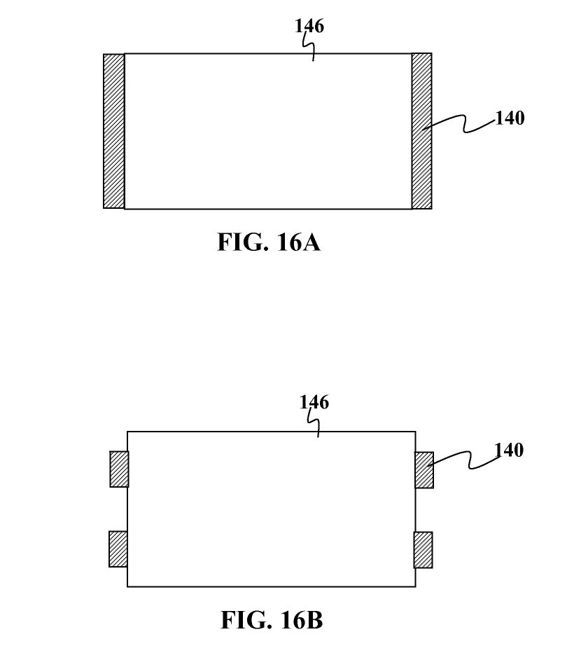

Referring now to FIG. 11, another embodiment of the present invention will now be described. This embodiment shows that a panel grip mechanism 130 may be used to attach the panel 60. The grip mechanism 130 includes a tapered jaw area 132 that will engage and hold the panel 60 when the panel 60 is inserted as indicated by arrow 134. Optionally, the panel 60 may be textured, abraded, or otherwise treated to increase frictional contact between the jaw area 132 and the panel 60. Optionally, glue, adhesive, and/or fasteners may also be used in addition to or in place of the compressive grip of jaw area 132 to secure the panel 60 in place. This panel grip mechanism 30 may be adapted for use with any of the embodiments described herein.

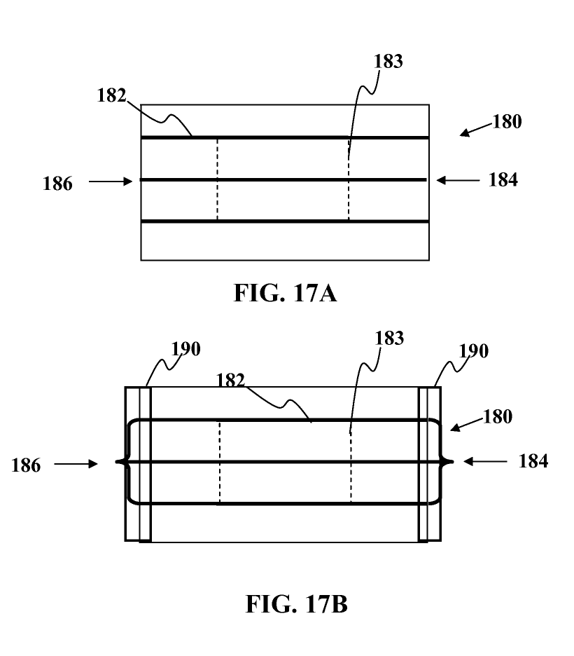

Referring now to FIG. 12, it should be understood that in other embodiments of the present invention, the mounting bracket 140 may be secured to one layer 142 of the panel 144 that is larger than another layer 146. Optionally, some embodiments have layers 142 and 146 of the same size. However, by having one layer of larger size, this presents an area for attachment to the mounting bracket 140 without shading any solar cells that may be positioned between the layers 142 and 146. Optionally, portions of layer 142 may be textured, abraded, or otherwise treated to increase frictional contact between the bracket 140 and the layer 142. Optionally, glue, adhesive, screws, set screws, clamps, and/or fasteners may also be used to secure the layer 142 in place. Of course, it should be understood that the top layer and the bottom layer may be different or same. Some embodiments, the top layer will be transparent while the bottom layer is not. Optionally, some embodiments may have front layer and back layer of different thicknesses, textures, shapes, and/or sizes. In one embodiment, the angle 141 is selected to be between 0 to 45 degrees from horizontal. Optionally, the angle 141 is selected to be between 0 to 30 degrees from horizontal. Optionally, the angle 141 is selected to be between 0 to 20 degrees from horizontal. Optionally, the angle 141 is selected to be between 0 to 10 degrees from horizontal.

FIG. 13 shows another embodiment of the present invention wherein the bracket 150 has a lower lip portion 152 that extends further beneath the layer 142 to provide greater area of surface contact. This increased area provides more support to the panel to minimize deflection and it also increases the area of the layer 142 that may be adhered, clamped, and/or fastened to the bracket 150. Optionally, lip portion 152 may extend across the backside of the layer 142 so as to support substantially half of the length of the layer 142

FIG. 14 shows a still further embodiment wherein the bracket 160 is configured for use with a panel 145 with a longer front side 147 and shorter backside layer 143. Again, glue, adhesive, screws, set screws, clamps, and/or fasteners may also be used to secure the layer 147 and/or 143 in place to bracket 160.

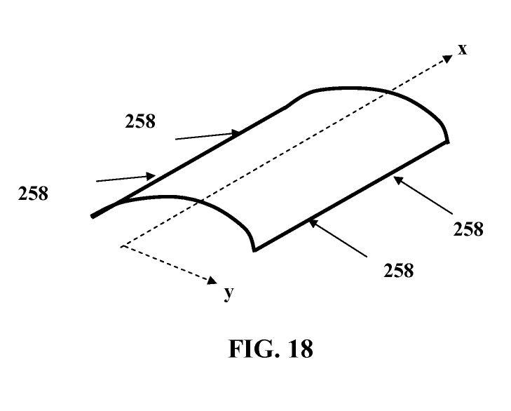

FIG. 15A shows another embodiment wherein the brackets 151 and 153 couple to a top and a bottom layer of the panel. The brackets may be glued, fastened, and/or otherwise attached to the panel layers. The panel layers may be roughed at these interface locations to more easily engage any adhesives used with the panels.

FIG. 15B shows a still further embodiment wherein the brackets 161 and 163 couple to a top and a bottom layer of the panel. A bottom portion 165 and 167 are larger than those portions coupled to the topside of the panel. This allows for more surface area to couple to the panel without shading areas of the panel.

FIG. 15C shows a still further embodiment wherein bracket 169 may be used to hold the panel in a curved configuration. The bracket 169 may be glued, fastened, and/or otherwise attached to the panel layers. The panel layers may be roughed at these interface locations to more easily engage any adhesives used with the panels.

FIG. 15D shows a still further embodiment wherein bracket 170 may be used to hold the panel in a curved configuration wherein the panel in a U-type configuration. The bracket 170 may be glued, fastened, mechanically bound, and/or otherwise attached to the panel layers. The panel layers may be roughed at these interface locations to more easily engage any adhesives used with the panels. A pad or other support 172 (shown in phantom) maybe placed to cushion or be a bump stop for the curved panel.

FIG. 15E shows a still further embodiment wherein the brackets 174 and 176 couple to a top and a bottom layer of the panel. A bottom portion may be larger than those portions coupled to the topside of the panel. This allows for more surface area to couple to the panel without shading areas of the panel. The brackets may be used to hold the panel in a curved configuration wherein the panel in a U-type configuration.

FIG. 15F shows that for any of the U-type mounting configurations, one end may be angled between 1 to 45 degrees or more from horizontal so that water or dirt or debris can flow in the direction as shown by arrow 178. The support 172 may also be shaped to follow continuously in contact with the angled configuration, creating a support 172 with more of a wedge shaped configuration.

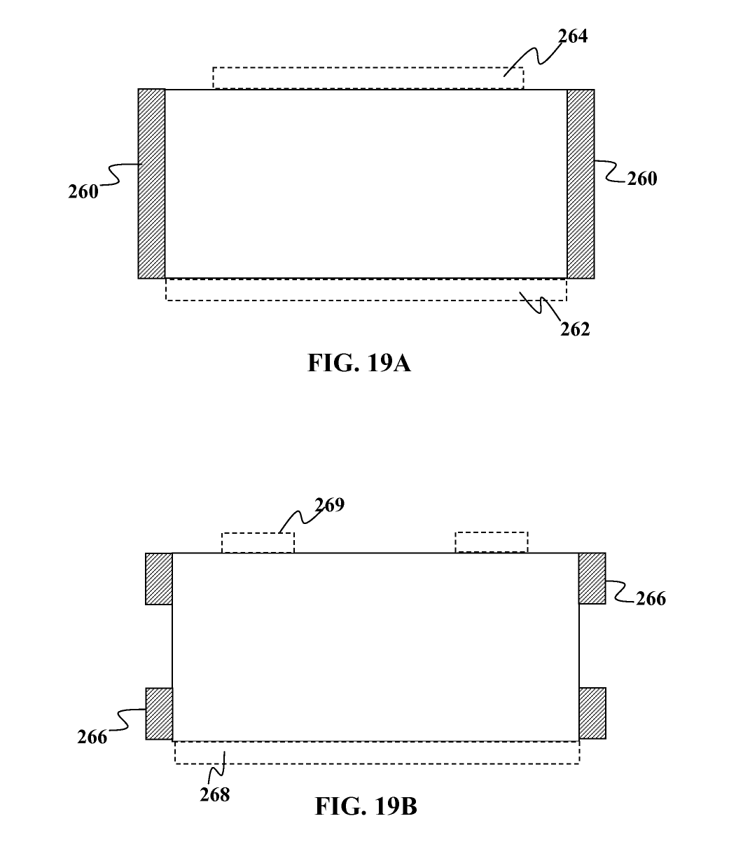

FIGS. 16A and 16B show that the brackets 140, 150, 151, 153, 160, 161, and/or 163 may be configured to span a full length of one edge of the panel as seen in FIG. 16A. Optionally, the brackets may be configured to span only a portion of one edge of the panel as seen in FIG. 16B (less than half the full length, less than ¼ the full length, less than ⅙ the full length, etc. . . . ). This full span and/or partial span is applicable to any of the brackets or mounting in the present application. Some embodiments may use combinations of full span, partial span brackets on the same or different edges. The brackets or mounting devices may be mounted on only one edge of the panel, two edges of the panel, three edges of the panel, or along all edges of the panel.

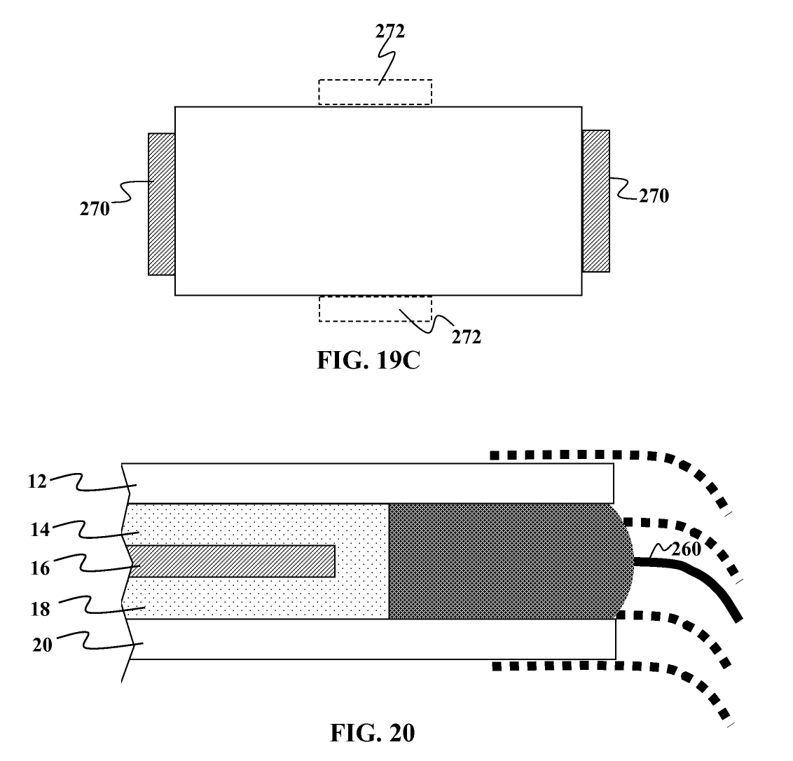

Referring now to FIGS. 17A-17B, another embodiment of a compression support member will now be described. FIG. 17A shows that a mesh or grid of wires, fiber, ribbon, or other elongate members that are in compression in at least one axis. In one embodiment, the grid may have a plurality of linear members that are gathered together and bundled into a fiber, braided wire, or ribbon to allow for compression. This allows a flat configuration to go to a round or other cross-sectioned configuration. Optionally, the linear members 172 may be coupled to rod, plate, or other elongate member 178 and compression is transferred through this common elongate member.

FIG. 17A shows another embodiment wherein the compression support member 180 comprises of directional fibers, wires or ribbons 182. These elements may be used to hold the panel in compression (in flat, upward arched, or downward ached configuration). They may span the short length of the panel or optionally span the long length of the panel. The fibers, wires, or ribbons 182 may include cross members 183 that are orthogonal or otherwise angled relative to the fibers, wires, or ribbons 182. Optionally, there are no cross members and only elongate members in one axis are used in compression as indicated by arrows 184 and 186.

FIG. 17B shows an alternative embodiment wherein the compression support member 180 with directional fibers, wires or ribbons 182 are coupled to brackets 190. The brackets 190 may be secured to supports rails (not shown) that are separate from the panel. Optionally, the brackets 190 are secured to the panel 60 and the brackets 190 may also be optionally secured to the support rails. The compression support members 180 may be used to maintain the compressive force and/or to keep a panel in an arched configuration.

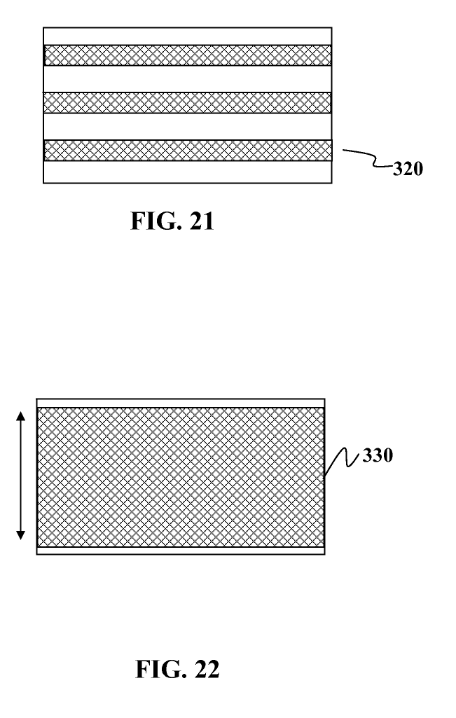

FIG. 18 shows that the use of compression may also help establish a preferred bending mode as the compression 258 in one axis of the panel makes it more difficult for the panel to bend in the non-compressed axis. The preferred bending mode may be in a longitudinal axis. Optionally, it may be in a latitudinal axis. Optionally, it may be along a long axis of the panel. Optionally, the panel may bend around a short axis of the panel. Optionally bending may occur in the X axis and/or Y axis.

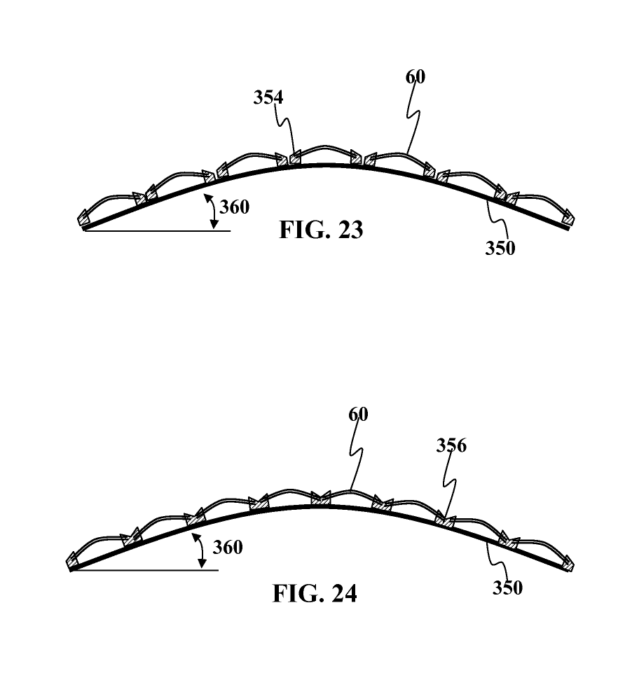

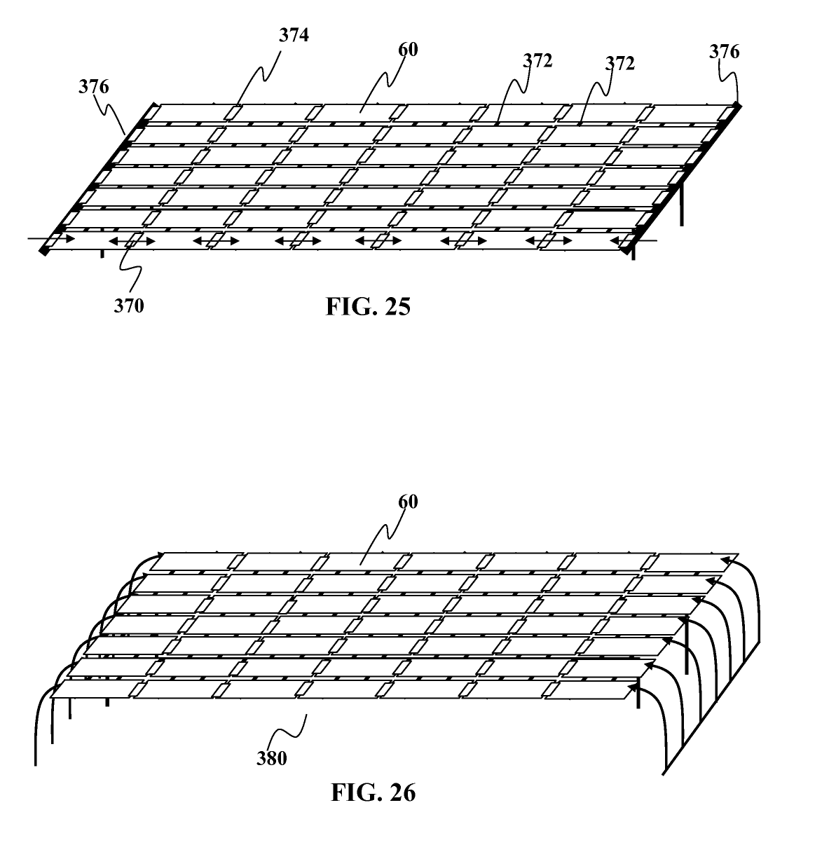

Referring now to FIG. 19A through FIG. 20 yet another embodiment of the present invention will now be described. FIG. 19A shows a panel with compressing members 260 that are attached to the panel. The compressing members may be but are limited to polymeric material, fabric, or other pliable material that may be nailed, screwed, weighed down, and/or glued to the support rail or a rooftop. The compressing members 260 as seen in FIG. 19A may be attached at one or more locations on the panel. For example, FIG. 19A shows that full length compressing member 262 and/or a non-full length compressing member 264 located on a different edge of the panel. These panels may use compressing members of the same size or of different size. Compressing members may also be used with mounting brackets of that span the entire edge or only a portion of the edge.

FIG. 19B shows that more than one compressing member 266 may be mounted on each edge of the panel 60. Compressing members may also be used with mounting brackets of that span the entire edge or only a portion of the edge. It should be understood that compressing members 268 and 269 of different sizes may also be used with the compressing members 266. Some may be ½ of the full length panel length along that edge. Optionally, some may be ⅓ of the full length panel length along that edge. Optionally, some may be ¼ of the full length panel length along that edge. Optionally, some may be ⅙ of the full length panel length along that edge. Optionally, some may be ⅛ of the full length panel length along that edge. Optionally, some may be 1/10 of the full length panel length along that edge.

FIG. 19C shows an embodiment of a panel wherein compressing members 270 and 272 are used. The panel has single compressing members on each edge and each of the compressing members are less than the full length of the edge. This may be for all edges of the panel. Optionally, some edges may use full length compressing members. Others may use more than one compressing member on one edge, but only a single compressing member on another edge.

FIG. 20 shows (in phantom) one or more other positions that may be used to attach to the panel. Some panels may have more than one compressing member on the same side. Some may have compressing members in all the configurations in FIG. 26 to allow for attachment. Some may have it attached between panel layers. Some may have it both between panels layers and/or over areas on the panel. Some may have a compression member in only one of the positions shown in FIG. 26.

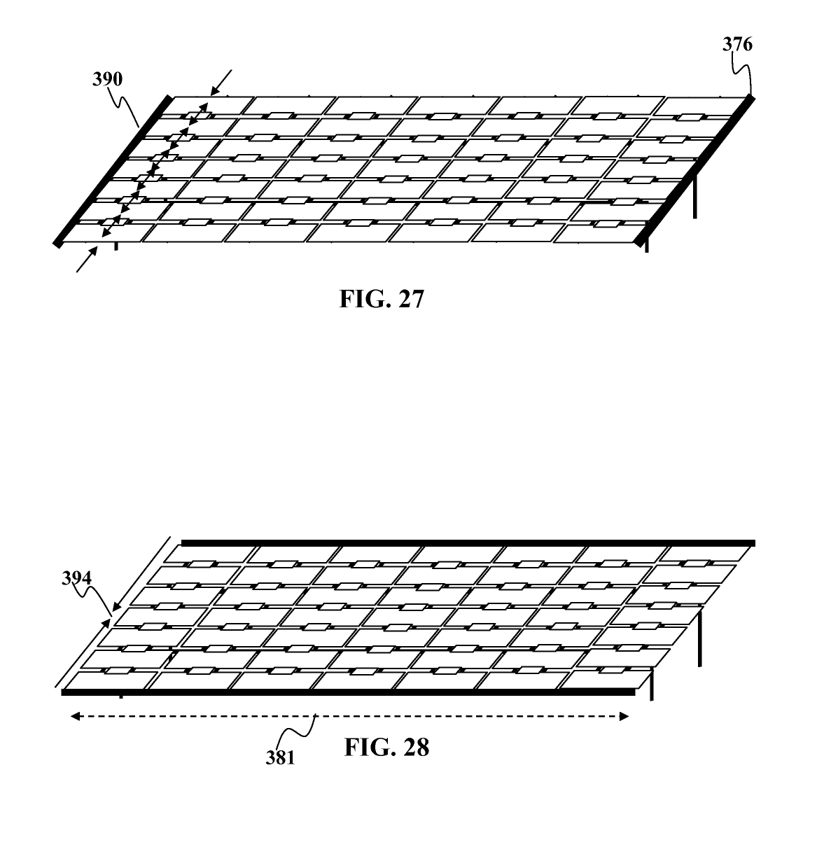

FIGS. 21 and 22 show that the compressing member may be in the form of strips 320 as shown in FIG. 21 or it may be in a larger sheet 330 that spans all, substantially all, at least 75% of the panel length, or a majority of the width of the panel. The strips 320 may be a fiberous layer (fiberboard, fiberglass, Kevlar, etc. . . . ), a webbed layer, a solid, or the like.

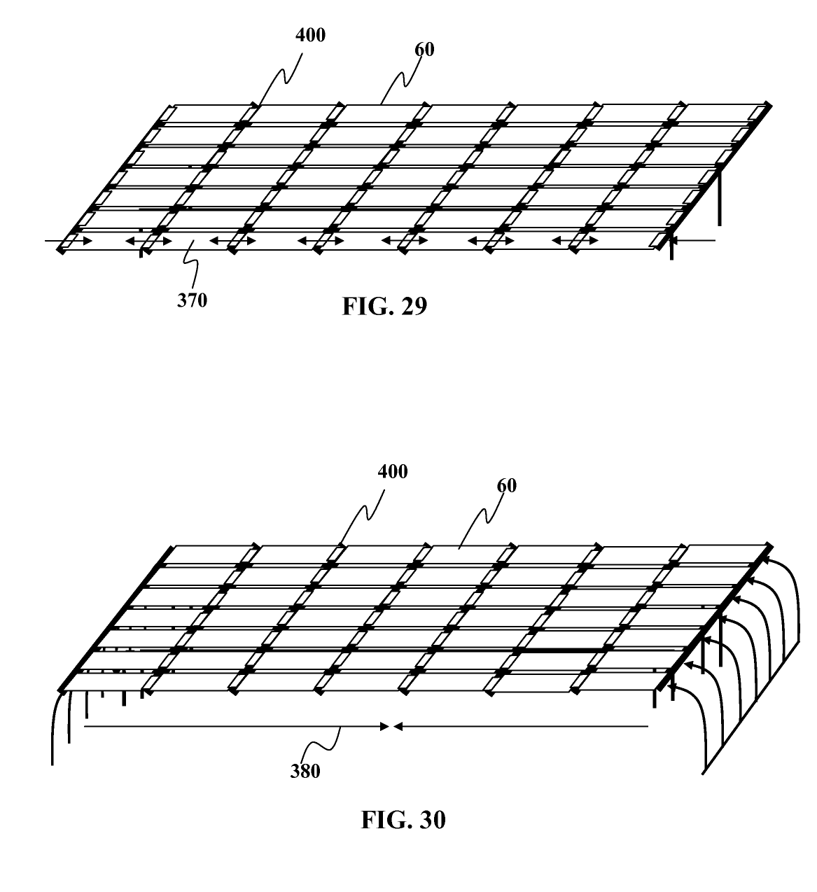

Referring now to FIGS. 23 and 24, it can be seen that embodiments of the present invention may be mounted on nonplanar support members. As seen in FIG. 23, the panels may be compressed and them mounted on an arched support 350. FIG. 24 shows that the mounting brackets 356 between panels may be shared. Optionally as seen in FIG. 23, the brackets 354 may be separate for each panel. In one nonlimiting example, the angle 360 may be between 0 and 45 degrees. The arched nature of the support 350 may help to keep the panels in an arched configuration as the support anchors for the panels are themselves on an arched surface that in turn helps to arch the panel. Of course, it should be understood that the panels may also be mounted on a flat, planar support and/or a downwardly arching support (downwardly angled in one embodiment between 0 and 45 degrees).

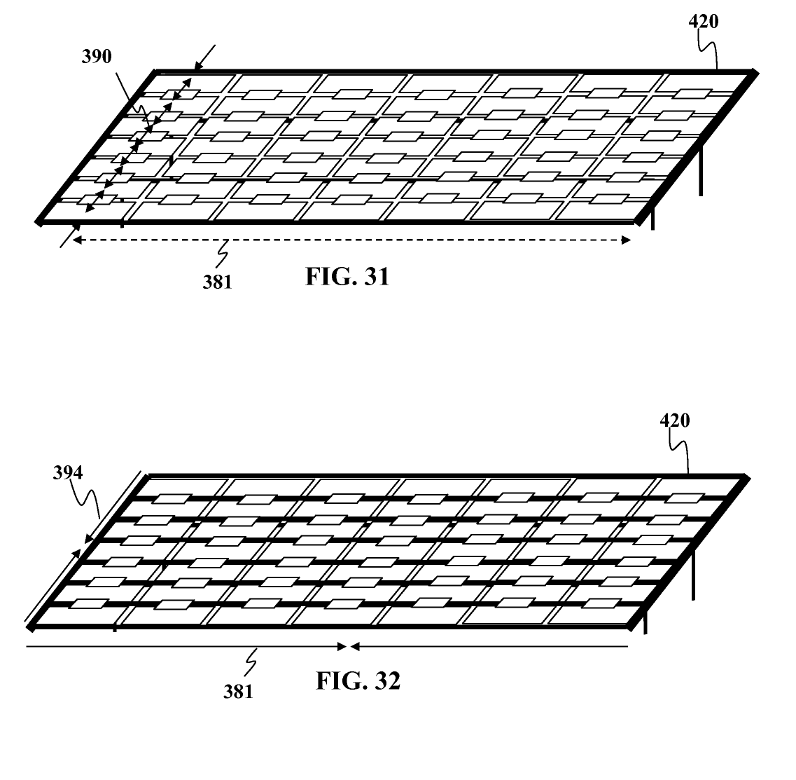

Referring now to FIG. 25, another embodiment of the present invention will now be described. FIG. 25 shows that compression may be compartmentalized, with each panel being individually compressed as indicated by arrows 370. Thus, compression on each panel may be set to be different (if desired). Optionally, the compression may be the same. In the present embodiment, it may be seen that there are support rails 372 beneath the panels. There may be special end rails to help create the desired compression. Connector 374 can also be used to create compression. For ease of illustration, the panels are shown in a flat configuration. It should be understood that the panels in this Figure and in any of the following figures may be in an arched (upward or downward) configuration in other embodiments. Some embodiments may only have some but not all panels in arched configuration (such as but not limited to alternating arched and non-arched panels).

FIG. 26 shows an embodiment wherein compression in one axis, in one row is passed from one panel to another. In this regard, only the ends of the rows of panels are anchored to provide compression. In this embodiment, the compressing mechanism may also be at the ends of the rows. The inter-panel connection therebetween the panels are slidable in nature and are not fixedly secured to allow the compression to pass between panels. This compression to be transmitted along the entire row as indicated by arrow 380. The non-end anchors may held in plane by guides or other structures, but are slidable to allow for compressive force to pass from panel to panel.

FIG. 27 shows an embodiment wherein the panels are each individually compressed along the short edge axis of each panel as indicated by arrow 390.

FIG. 28 show an embodiment wherein the entire column of panels are compressed along the short edge axis of each panel. The panels are slidably mounted along such support rails to allow compression to pass between panels. In this manner, an entire string of panels may be compressed as indicated by arrow 394. Some embodiments may also compression or compress the panels in an orthogonal axis, such as indicated by arrow 381.

Referring now to FIG. 29, another embodiment of the present invention will now be described. FIG. 29 shows that compression may be compartmentalized, with each panel being individually compressed as indicated by arrows 370. Thus, compression on each panel may be set to be different (if desired). FIG. 29 also shows that panels share a common rail 400 and that the panels are mounted between the common rail as shown in FIG. 3 or on the common rail 400.

FIG. 30 shows an embodiment wherein compression in one axis, in one row is passed from one panel to another. In this regard, only the ends of the rows of panels are anchored. The inter-panel connection therebetween are slidable in nature and are not fixedly secured to allow the compression to pass between panels.

Referring now to FIG. 31, another embodiment of the present invention will now be described. FIG. 31 shows that compression may be compartmentalized, with each panel being individually compressed as indicated by arrows 390. Thus, compression on each panel may be set to be different (if desired). FIG. 31 also shows that a frame 420 around the entire array to provide supports for compressing the panels. Some embodiments may also compression or compress the panels in an orthogonal axis, such as indicated by arrow 381.

FIG. 32 shows an embodiment wherein compression in one axis, in one row is passed from one panel to another. In this regard, only the ends of the rows of panels are anchored. The inter-panel connection therebetween are slidable in nature and are not fixedly secured to allow the compression to pass between panels as indicated by arrows 392. The panels may also be compressed in an orthogonal axis in place or in addition to the compression shown in FIG. 32. FIG. 32 also shows that a frame 420 around the entire array to provide supports for compressing the panels. Some embodiments may also compression or compress the panels in an orthogonal axis, such as indicated by arrow 381.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, although glass is the layer most often described as the top layer for the panel, it should be understood that other material may be used and some multi-laminate materials may be used in place of or in combination with the glass. Some embodiments may use flexible top layers or coversheets. By way of nonlimiting example, the backsheet is not limited to rigid panels and may be adapted for use with flexible solar panels and flexible photovoltaic building materials. Embodiments of the present invention may be adapted for use with superstate or substrate designs. Embodiments of the present invention may be used with mounting apparatus such as that shown or suggested in U.S. Application Ser. No. 61/060,793 filed Jun. 11, 2008 and fully incorporated herein by reference for all purposes. U.S. Provisional Application Ser. No. 61/097,518 filed Sep. 16 2008 is fully incorporated herein by reference for all purposes. PCT application PCT/U.S.09/48731 filed Jun. 25, 2009 is fully incorporated herein by reference for all purposes. Any of the embodiments herein showing an upward arched panel may also be configured for use with U-shaped downward arched panels.

Optionally, embodiments of the present invention may use frames or be without frames around the panel. The embodiments herein are not limited to only glass-glass, frameless panels. Some embodiments may use partial frames such as only on substantially on edge of the panel, two edges of the panel, or three edges of the panel. Optionally, others may be used with panels that are without a top or bottom layer, but are compressing elongate rod shaped solar cells that may be without a top layer or a bottom layer. In this manner, the plurality of rods and/or transparent tubes around these rods may be compressed in the manner described herein to increase ability to carry load. The compression may be in the longitudinal axis (long axis) of the rod shaped tubes surrounding such elongate cells.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

1. A method comprising:
compression mounting a photovoltaic panel such that at least one rigid or semi-rigid layer of the photovoltaic panel is a constant state of compression in at least a first axis when the photovoltaic panel is mounted for use.

2. The method of claim 1 wherein the layer in the constant state of compression comprises of a glass layer.

3. The method of claim 2 wherein the layer comprises of an un-tempered glass material.

4. The method of claim 2 wherein the layer comprises of a tempered glass material.

5-7. (canceled)

8. The method of claim 1 wherein the panel has a total photovoltaic surface area of at least 1.5 m².

9. The method of claim 1 wherein the panel has a total photovoltaic surface area of at least 2 m².

10. The method of claim 1 wherein compression is applied in an amount sufficient for the panel to withstand a load of at least 2400 pa without breakage that an identical panel without the compression mounting could not withstand.

11. The method of claim 1 wherein compression is applied in an amount sufficient for the panel to withstand a load of at least 4000 pa without breakage that an identical panel without the compression mounting could not withstand.

12. The method of claim 1 wherein compression is applied in an amount sufficient for the panel to withstand a load of at least 5400 pa without breakage that an identical panel without the compression mounting could not withstand.

13-14. (canceled)

15. The method of claim 1 wherein the layer being compressioned is a front-side layer of the panel.

16. The method of claim 1 wherein the layer being compressioned is a back-side layer of the panel.

17. The method of claim 1 wherein at least two layers of the panel are in a constant state of compression when the panel is mounted for use.

18. The method of claim 1 wherein compressing the layer compressions the entire panel in one axis.

19. The method of claim 1 further comprising attaching a mounting bracket directly in contact to the layer to be placed in constant compression.

20. The method of claim 19 wherein the mounting bracket is glued to the layer.

21-25. (canceled)

26. The method of claim 1 further comprising using a mounting bracket that is configured to allow the panel to flex in one axis.

27. The method of claim 1 further comprising attaching a plurality of cables to the panel to provide compression.

28. The method of claim 1 further comprising attaching a separate layer of material to extend across an entire underside of the panel and compressing that separate layer compressions the layer in the panel.

29. The method of claim 1 further comprising attaching a net-like layer of material to extend across an entire underside of the panel and compressing that net-like layer compressions the layer in the panel.

30. The method of claim 1 further comprising attaching a separate layer of material between a topside layer of the panel and an bottom layer of the panel, wherein the separate layer extends across the panel in one axis and compressing that separate layer compressions the layer in the panel.

32-47. (canceled)
